(19) United States
(12) Patent Application Publication
(10) Pub. No.: US 2023/0262032 A1
(43) Pub. Date: Aug. 17, 2023

(54) OBFUSCATION OF INPUT DATA VALUES INTO OBSERVABLE DATA VALUES USING SYMBOLOGY-BASED ENCODINGS

(71) Applicant: REFINITIV US ORGANIZATION LLC, New York, NY (US)

(72) Inventor: Hayden MELTON, Philadelphia, PA (US)

(73) Assignee: REFINITIV US ORGANIZATION LLC, New York, NY (US)

(21) Appl. No.: 18/108,030

(22) Filed: Feb. 10, 2023

Related U.S. Application Data
(60) Provisional application No. 63/309,043, filed on Feb. 11, 2022.

(51) Int. Cl. H04L 9/40

(52) U.S. Cl. CPC H04L 63/0428

(57) ABSTRACT

The disclosure relates to systems and methods for symbology-based obfuscation. A system may access an input data value obtained from an input data message. The system may obtain a symbology encoding based on the input data message, the symbology encoding including a precision parameter. The system may generate an output data value based on the input data value and the symbology encoding, the output data value obfuscating the input data value based on the precision parameter defined in the symbology encoding. The system may prepare an output data message based on the output data value that obfuscates the input data value. The system may transmit the output data value obfuscating the input data value to one or more recipients to obfuscate the input data value while providing an indication of the input data value within the precision parameter.

### RELATED APPLICATIONS

This application claims priority to U.S. Provisional Patent Application No. 63/309,043, filed Feb. 11, 2022, entitled “Price and Size Elision,” which is incorporated by reference in its entirety herein.

### BACKGROUND

Data messages transmitted through a computer network may include various types of data values depending on the context in which they are implemented. Some of these data values may quantitatively describe a subject. The actual data values may contain sensitive information about the subject or otherwise information that should not be exposed to a recipient. Data messages may also be subject to multiple transmission over a network when new data is available. These and other issues may exist for communicating data messages over a computer network.

### SUMMARY

The disclosure relates to systems, methods, and computer-readable media for obfuscating and aggregating data values in a data message based on a symbology encoding. Obfuscating and aggregating the data values may address the problems of transmitting sensitive data over a network and the problem of multiple transmissions when new data is available.

The data values to be obfuscated may quantitatively describe a subject. The particular type of subject may vary depending on the particular implementation. For example, a subject may include a vehicle described in a data message by data values relating to a speed, location, and/or other quantifiable information relating to the vehicle. In another example, the subject may include a network device described in a data message by data values relating to a transmission speed, computational capability (such as processor speed, memory, and so forth), and/or other quantifiable information relating to the network device. In yet another example, the subject may include an instrument traded on an electronic exchange described in a data message by data values relating to a price, size, and/or other quantifiable information relating to the instrument. Obfuscating the data values may mitigate against the transmission of sensitive data. Aggregating the data values may reduce instances of multiple transmissions over the computer network, reducing computational and network overhead. Furthermore, obfuscating and aggregating actual data values may reduce transmission of more granular actual data values as new actual data values become available since they may be aggregated and obfuscated along with other data values.

The system may use a symbology encoding to validate and/or obfuscate data values. A symbology encoding is information that is used to obfuscate an actual data value into an observable data value that is different than the actual data value. In particular, a symbology-based validator may receive an input data value, access a symbology encoding, and validate the input data value based on the symbology encoding. A symbology-based aggregator may generate observable data values based on the symbology encoding and an actual data value. In other words, the symbology-based aggregator may obfuscate the actual data value based on the symbology encoding.

### BRIEF DESCRIPTION OF THE DRAWINGS

Features of the present disclosure may be illustrated by way of example and not limited in the following Figure(s), in which like numerals indicate like elements, in which:

FIG. 1 illustrates an example of a computer environment for symbology-based encoding and validation of data messages;

FIG. 2 illustrates an example of a method for symbology-based validation of data messages;

FIG. 3 illustrates an example of a method for symbology-based encoding of data messages;

FIG. 4 illustrates an example of a method for generating output data messages using symbology-based encoding of input data messages;

FIG. 5 illustrates an example of an implementation of symbology-based validation and encoding of data messages in a networked computer system; and

FIG. 6 illustrates an example of a computer system illustrated in FIGS. 1 and 5.

### DETAILED DESCRIPTION

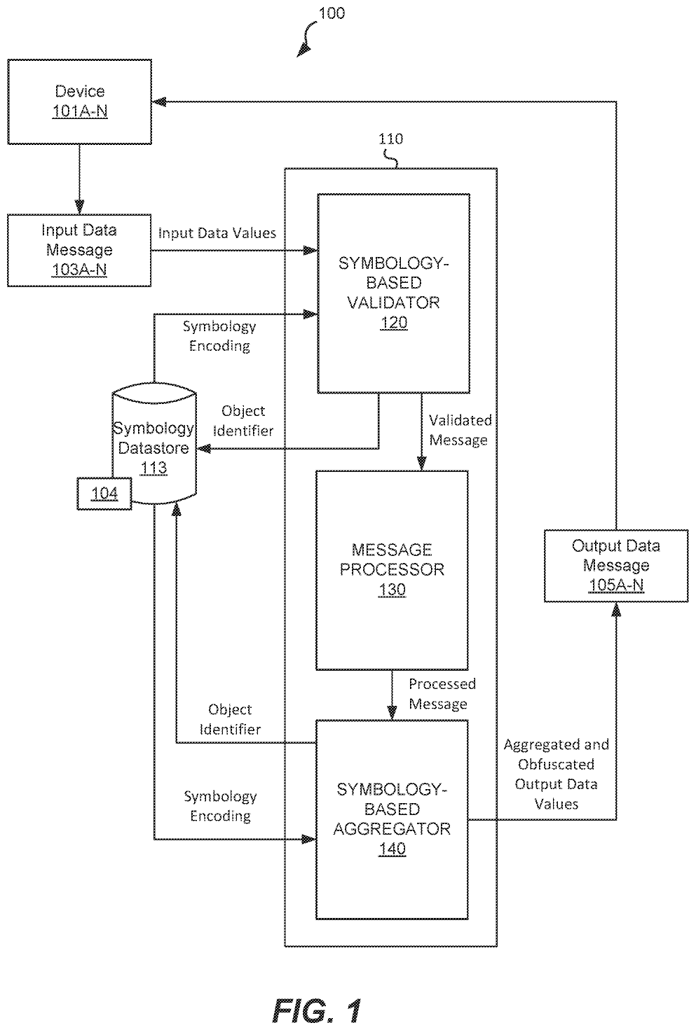

FIG. 1 illustrates an example of a computer environment 100 for symbology-based encoding and validation of input data messages 103. The computer environment 100 may include a device 101, a computer system 110, and/or other components. The device 101 may transmit an input data message 103 to the computer system 110. Other devices 101 (not shown) may transmit other input data messages 103 to the computer system 110 as well. Each input data message 103 may include a payload having one or more input data values. The input data values may include various types of data depending on the context in which the computer environment 100 is implemented. In whichever context is implemented, the computer system 110 may access a symbology encoding 104, which may be stored in a symbology datastore 113, and obfuscate the actual value of the input data value so that it is not discernible to a recipient after obfuscation. In some examples, the input data values may relate to a subject that is the subject matter of the input data message 103.

A symbology encoding 104 is information that is used to obfuscate an actual data value into an observable data value that is different than the actual data value. In this context, the term obfuscate, obfuscating, and similar terms means generating an observable data value based on an actual data value that does not reveal the actual data value. In some instances, such obfuscation will provide a coarser version of the actual data value without revealing the actual data value. The symbology encoding 104 may include a precision parameter that is used to associate the actual data value (such as an input data value in the input data message 103) with an observable data value. The precision parameter is data that defines how an actual data value is to be obfuscated into an observable data value. For example, the precision parameter may include a range (such as a start value and end value for numeric values, a location radius for location information, and so forth) into which the actual data value is placed. The precision parameter may by represented by a symbol in the observable data value to provide a coarse indication of the actual data value while obscuring the actual data value.

In some examples, the symbology encoding 104 is subject-specific. For example, actual values of a first subject may be specifically obfuscated by a first symbology encoding specific to the first subject and actual values of a second subject may be specifically obfuscated by a second symbology encoding specific to the second subject. In these examples, each of these symbology encodings may include or be associated with a subject identifier that identifies the subject to which the symbology encoding 104 specifically relates. When a data message relating to a subject is received, the computer system 110 may extract a subject identifier from the data message and access the symbology encoding 104 specific to the subject from the symbology datastore 113.

The computer system 110 may use the symbology encoding 104 to generate observable data values that obfuscate the actual data values while providing coarse data about the actual data values based on the precision parameter. The computer system 110 may also use the symbology encoding 104 to validate input data messages 103 having data values that may be based on the symbology encoding 104 and/or generate observable data values from actual data values.

The computer system 110 may receive the input data message 103, validate the input data values, process the validated input data values and encode and aggregate the processed input values along with other processed input values based on a symbology encoding 104 to generate an output data message 105.

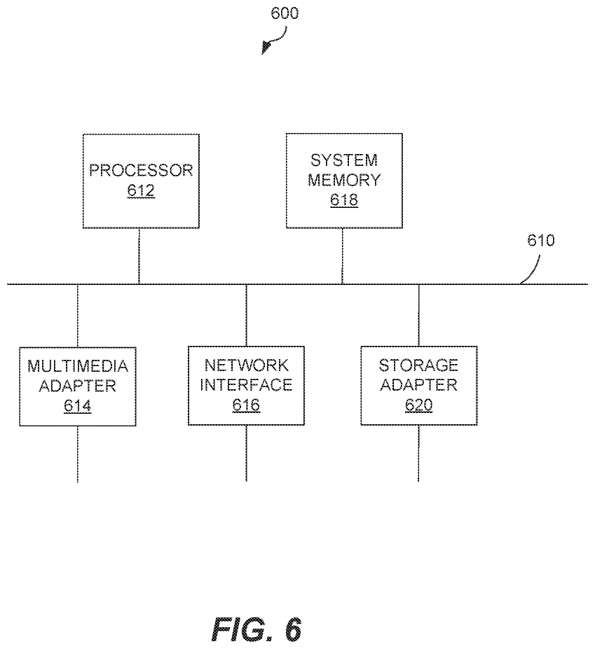

The computer system 110 may include a symbology-based validator 120, a message processor 130, a symbology-based aggregator 140, and/or other features or components. Each of the features 120, 130, 140 may be implemented in hardware and/or software. For example, each of the features 120, 130, 140 may be together or separately implemented by some or all of the computer system illustrated in FIG. 6.

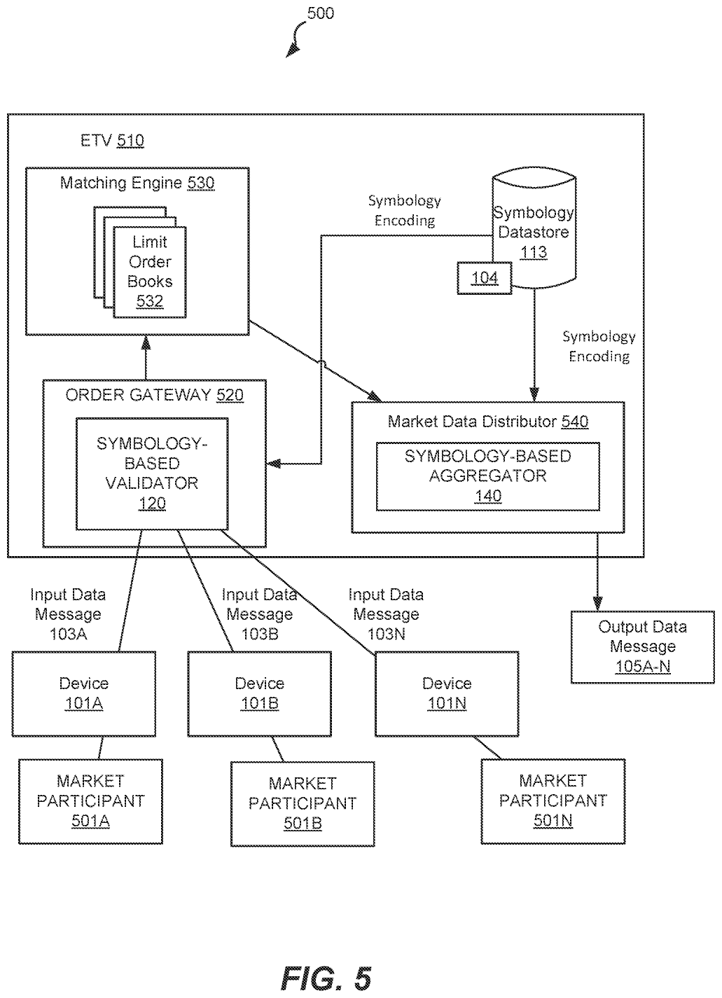

The symbology-based validator 120 may validate an input data value of an input data message 103 based on a symbology encoding 104 stored in the symbology datastore 113. The symbology-based validator 120 may output a validated data message for processing. The message processor 130 may process the validated data message. The message processor 130 may process validated data messages in various contexts, an example of which is illustrated in FIG. 5.

The symbology-based aggregator 140 may encode a data value based on the symbology encoding 104. For example, the symbology-based aggregator 140 may aggregate input data values relating to a subject. If the subject is a vehicle and an input data value is a speed, then the symbology-based aggregator 140 may aggregate the speeds of vehicles from data messages 103. To illustrate, the symbology-based aggregator 140 may aggregate data from a plurality of data messages 103 relating to vehicles based on speed data values. In this example, the aggregation may result in a dataset including: ten vehicles travelled at 57 miles per hour, five vehicles travelled at 63 miles per hour, and seven vehicles travelled at 64 miles per hour. If the symbology encoding 104 includes a precision parameter specifying intervals of 5 miles per hour, then obfuscating the actual data values of 57, 63, and 64 miles per hour would result in: ten vehicles travelled at ≤60 miles per hour and twelve vehicles travelled at ≤65 miles per hour. Similar obfuscations may be made to obfuscate actual location data values (such as a geocoordinate point) obfuscated to a geocoordinate radius or other coarse location obfuscation that may be specified by a symbology encoding 104.

It should be noted that in the speed example, the intervals specified by the precision parameter of the symbology encoding 104 was five miles per hour. In this case, only one symbol (“≤”) is used to convey the obfuscated data values, with the assumption that the prior value in the range is equal to the precision parameter. For instance, “≤65 miles per hour” impliedly denotes that a vehicle speed, x, is given by: “60<x≤65.” It should be further noted that the intervals may not be equal to one another and that the precision parameter may be more granularly configured. For instance, the precision parameter may include intervals: 0-15 miles per hour; 16-25 miles per hour, 25-50 miles per hour, and so forth. In some examples, the precision parameter may specify a terminal increment, which may be symbolized by a “+” or other symbol. The terminal increment means an open-ended increment that represents the last interval from among other intervals. For example, a terminal increment of “75+” indicates speeds in excess of 75 miles per hour.

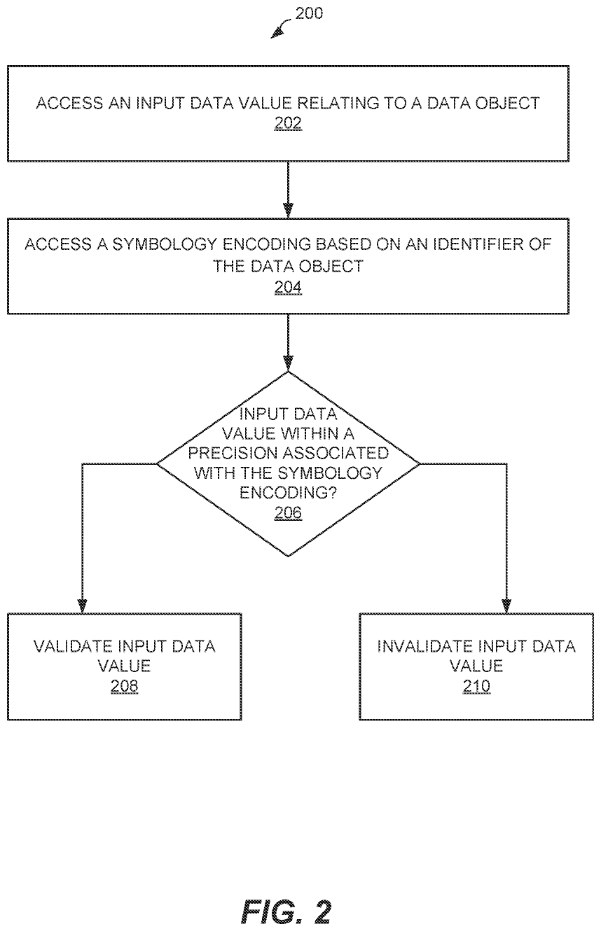

FIG. 2 illustrates an example of a method 200 for symbology-based validation of data messages (such as input data messages 103). The method 200 will be described with example references to FIG. 1. At 202, the method 200 may include accessing an input data value relating to a subject. The type of subject will vary depending on the context in which the method 200 is implemented. FIG. 5 illustrates an example in which the subject relates to an instrument traded on an electronic trading venue and the input data value is a price and/or size of an order for the instrument.

At 204, the method 200 may include accessing a symbology encoding (such as symbology encoding 104), The symbology encoding may be based on an identifier of the subject. For example, the symbology encoding may be specifically configured to obfuscate the input data value of the subject.

At 206, the method 200 may include determining whether the input data value is within a precision associated with the symbology encoding. For example, the symbology encoding may include a level of precision for obfuscating input data values. If the input data is within the level of precision specified by the symbology encoding, at 208, the input data value is validated. Otherwise, at 210, the input data value is invalidated.

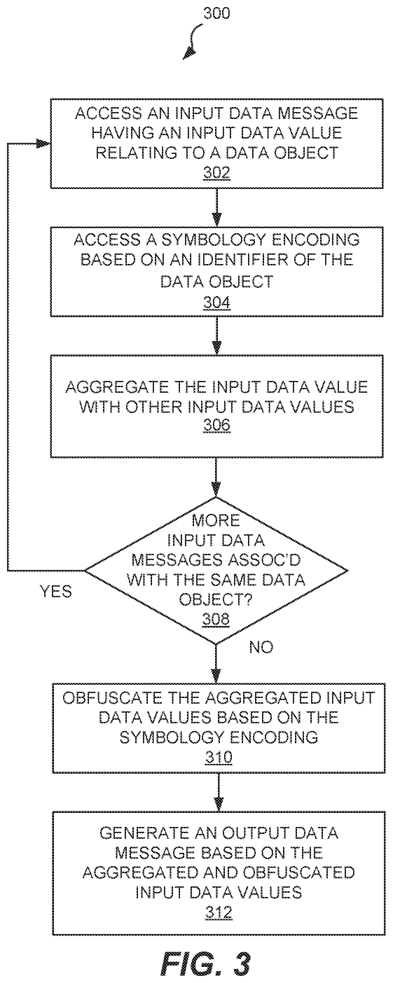

FIG. 3 illustrates an example of a method 300 for symbology-based encoding of data messages (such as input data messages 103). The method 300 will be described with example references to FIG. 1. At 302, the method 300 may include accessing an input data message (such as input data message 103) having an input data value relating to a subject.

At 304, the method 300 may include accessing a symbology encoding (such as symbology encoding 104) based on an identifier of the subject. At 306, the method 300 may include aggregating the input data value with other obfuscated input data values associated with the same subject. At 308, the method 300 may include determining whether there are more input data messages associated with the same subject. If there are more input data messages, the method 300 may return to 302 to process the additional input data messages. If not, at 310, the method 300 may include obfuscating the aggregated input data values associated with the same subject. At 312, the method 300 may include generating an output data message (such as an output data message 105) based on the aggregated and obfuscated input data values.

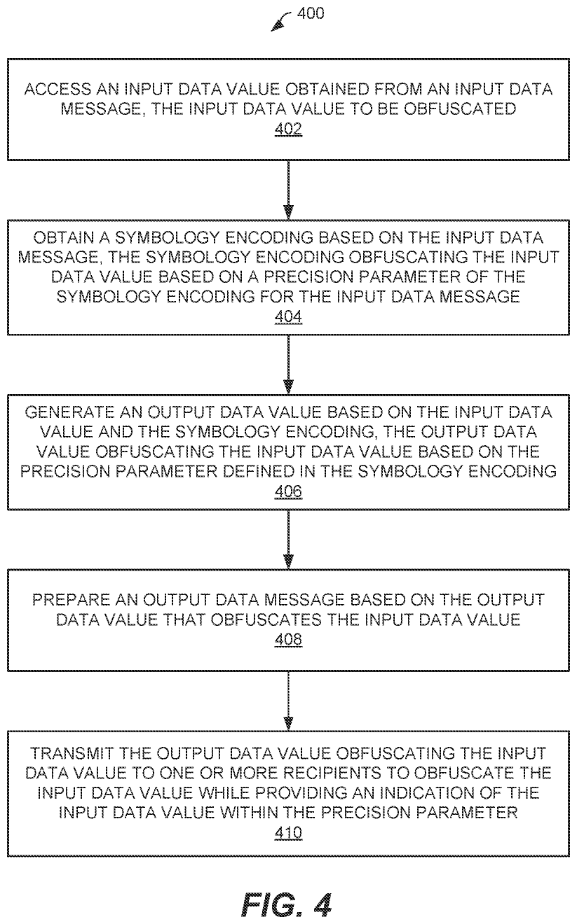

FIG. 4 illustrates an example of a method 400 for generating output data messages 105 using symbology-based encoding of input data messages 103. At 402, the method 400 may include accessing an input data value obtained from an input data message, the input data value to be obfuscated. At 404, the method 400 may include obtaining a symbology encoding based on the input data message, the symbology encoding obfuscating the input data value based on a precision parameter of the symbology encoding for the input data message.

At 406, the method 400 may include generating an output data value based on the input data value and the symbology encoding, the output data value obfuscating the input data value based on the precision parameter defined in the symbology encoding. At 408, the method 400 may include prepare an output data message based on the output data value that obfuscates the input data value. At 410, the method 400 may include transmitting the output data value obfuscating the input data value to one or more recipients to obfuscate the input data value while providing an indication of the input data value within the precision parameter.

FIG. 5 illustrates an example of an implementation of symbology-based validation and encoding of data messages in a networked computer environment 500. The networked computer environment 500 may include an electronic trading venue (ETV) 510 and one or more market participants 501A-N. Market participants 501 are, for example, entities that interact with the ETV 510 via respective devices 101. To illustrate obfuscation of input data values based on the symbology encoding 104, a tick size data value and/or price data value will be described in the examples that follow.

The ETV 510 may implement examples of various components illustrated in FIG. 1 that improves the operation of the ETV 510. For example, the ETV 510 include one or more order gateways 520 that implement a symbology-based validator 120, one or more matching engines 530 that are examples of a message processor 130, one or more market data distributors 540 that implement the symbology-based aggregator 140, and/or other components.

An operator of the ETV 510 may configure a symbology encoding 104 to specify two distinct tick sizes: a canonical tick size and an observable tick size. This specification may be specific to a given instrument traded on the ETV 510. The canonical tick size is the smaller of the two and governs the precision of prices that limit orders submitted into the venue can have. The observable tick size governs the precision at which price levels appear in market data sent from the venue to market participants. Since the observable tick size is larger than the canonical tick size it will usually have an aggregation type effect. For instance, if the observable tick size on the spot foreign exchange (FX) instrument ‘GBP/USD is 0.0001 (i.e., ‘whole pips’) and the canonical tick size on the same instrument is 0.00001 (i.e., ‘tenth pips’) then bids between 1.35000 and 1.35009 (inclusive) would be aggregated to a single price-level of 1.3500 in market data. In this way, for the purposes of computing market data updates from the limit order book 532, bids would usually be rounded down to the observable tick size, and offers would usually be rounded up to that tick size.

To disincentivize ‘pinging’ of the limit order book 532 by market participants 501, the venue operator may impose further restrictions on the price precision of certain order types. For instance, the price precision of immediate-or-cancel (IOC) orders may be set to the observable tick size while other order types that can be inserted into the book as bids and offers and have a minimum quote life (MQL) may be set to the canonical tick size. Regardless of which tick size specifies the price precision of a specific order, the venue may otherwise ensure liquidity-taking orders receive price-improvements by matching at the price of standing bids and offers. For instance, if a liquidity taking order is submitted to buy with a limit price of 1.0005, and is matched against a (liquidity-providing) offer whose limit price is 1.00048, the price at which the trade would occur is 1.00048, providing a two tenths of a pip price improvement to the taker.

The venue operator may configure the symbology encoding 104 in a manner that relaxes the price precision restrictions on the ‘last traded price’ field of the market data so that field alone contains the canonical price at which the trade occurred, even though other price-levels in the market data are constrained by the observable tick size. In particular, an instrument definitions database of the ETV 510 may be enhanced to store some or all of the symbology datastore 113. For example, the instrument definitions database may be configured to store a symbology encoding 104 that includes the canonical and observable tick sizes for each instrument. This new tick size information is provided to the order gateway 520 and market data distributor 540.

An order gateway 520 may receive input data messages 103 from devices 101 of market participants 501. For example, through a respective device 101, a market participant 501 may log onto ETV 510, which may generate an order session. During a given order session, a market participant 501 may submit an input data message 103 through an order gateway 520. The input data message 103 may contain an order (such as cancels, replaces, new order requests, etc.) for an instrument traded on the ETV 510. The input data values of an input data message 103 may include a price, a size (quantity of the instrument associated with the order), and/or other information about an order for an instrument traded on the ETV 510. The input data message 103 may be formatted according to a FIX message format, although other types of formats may be additionally or alternatively used.

An order gateway 520 may be improved to include a symbology-based validator 120 that validates the incoming orders and transmit the validated orders to the matching engine 530. In this context, the symbology-based validator 120 ensures that order types have the precision required by the venue and rejects orders that do not. Following from the preferred embodiment described above this may involve checking orders with an immediate-or-cancel (IOC) time-in-force are rejected if they do not have observable tick size precision, and other types of orders are rejected if they do not have canonical tick size precision. Orders that are not rejected are forwarded to the matching engine 530 for processing.

The matching engine 530 may process an input data message 103 by matching the order contained therein with other orders from other input data messages 103. The matching engine 530 may maintain one or more limit order books 532, which may track a bid or offer state for the instruments that trade on them. A bid or offer state is indicative of bids and/or offers with respect to the instrument. One example of a bid or offer state is the state of a central limit order book (“CLOB”), although other types of mechanisms may be used to track bid or offer states. The term “CLOB” is used by example and not limitation. Other ways to maintain a bid or offer state may be used as well so as aggregate supply and demand, perform matching, organize orders, etc., on a given instrument or group of instruments.

The matching engine 530 may generate market update information reflecting the updated state of the limit order book and transmit the market update information to the market data distributors 140. For example, each time a new order is received by matching engine 530, a limit order book 532 is updated based on the received order. In other words, a new order may trigger generation and transmission of market date update information that reflects the new order. In some instances, the market data update information includes a copy of the limit order book 532. Each market data distributor 540 may generate market data updates based on the market data update information from matching engine 530, and transmit the market data updates to market participants 501 that are logged onto in an output data message 105.

The market data updates may include information such as the price and size of the last trade that occurred on an instrument. In some examples, the market data distributor 540 may obfuscate the actual values of the price, size, and/or other input data values based on a symbology encoding 104. In some examples, the symbology encoding 104 may be specifically associated with the instrument for which the market date update relates. In these examples, the symbology datastore 113 may store a symbology encoding 104 in association with an identifier (such as a ticker symbol) for a given instrument. In this manner, for a given instrument identifier, a corresponding symbology encoding 104 may be used to obfuscate data values for the instrument in a market data update.

When a market data distributor 540 prepares an output data message 105 containing a market data update, the market data distributor 540 may execute the symbology-based aggregator 140 to obfuscate the price, size, and/or other data value associated with instruments traded on the ETV 510. For example, the market data distributor 540 may access the symbology encoding 104 for relevant instruments to be included in the market data update. In this context, the symbology-based aggregator 140 may round price-levels in the limit order book 532 down for bids and up for offers so as to aggregate price-levels in the market data updates to the observable tick size as output. The symbology-based aggregator 140 may also allow the last traded price field in the market data updates to be provided with canonical precision. Updates it conventionally receives from the matching engine 530 as input will generally have canonical precision prices in them.

In an example of size obfuscation, the operator of the ETV 510 may configure a symbology encoding 104 that specifies a set of quantity ranges for each instrument on the venue that become observable to market participants 501 in the market data updates the venue sends them. For non-obfuscated market data updates, an electronic trading venue may provide the actual quantity at each price-level. By contrast, the market data distributor 540 may not provide the actual quantities, but rather aggregates the prices into predetermined ranges as defined by the symbology encoding 104. For instance, the symbology encoding 104 for a particular spot FX instrument such as GBP/USD may be configured to aggregate sizes in multiples of 5 million in base currency. The market data updates that result for this instrument would then show only multiples of 5 million at each price level.

For example, Table 1A shows an example of non-obfuscated market data updates.

| Type | Price | Actual Size |
|---|---|---|
| Ask | 1.05 | 5 Mio |
| Ask | 1.04 | 13 Mio |
| Ask | 1.03 | 2 Mio |
| Bid | 1.02 | 8 Mio |
| Bid | 1.01 | 3 Mio |
| Bid | 1.00 | 17 Mio |

Table 1B shows the same actual data values as shown in Table 1A but with obfuscated sizes based on a symbology encoding 104 that specifies an aggregation into equal intervals of 5 million with the “≤” symbology notation.

| | | Obfuscated Symbology | |
|---|---|---|---|
| Type | Price | (for size) | |
| Ask | 1.05 | ≤5 | Mio |
| Ask | 1.03 | ≤15 | Mio |
| Ask | 1.03 | ≤5 | Mio |
| Bid | 1.02 | ≤10 | Mio |
| Bid | 1.01 | ≤5 | Mio |
| Bid | 1.00 | ≤20 | Mio |

It should be noted that the symbology encoding 104 in this instance specifies that the actual sizes at each price level are to be obfuscated by aggregating them into ranges of 5 million each as illustrated. It should be further noted that the obfuscated sizes in which the ranges are the same as illustrated in Table 1A (such as 5 million for each interval) may be assumed to be continuous with a previous obfuscated size. For instance, ≤10 Mio (million) may be assumed to be continuous with the prior range of ≤5 Mio such that the actual size is >5 Mio and ≤10 Mio. However, the increments or ranges need not be equal in size. Furthermore, after a certain size threshold the market operator may indicate there is more than that size with the ‘+’ symbol. For example, if the size threshold is 20 Mio, actual sizes that exceed this threshold may be obfuscated as “20+Mio,” indicating that more than 20 million is available at that price-level. The specific increments may be provided to participants in the instrument definitions otherwise conventionally they receive upon connecting to the venue. Price-levels with zero quantity available may not be shown at all.

In these examples, the symbology encoding 104 may be used to obfuscate other input data values of orders such as prices in a similar manner. For example, the symbology encoding 104 may be configured to define price obfuscation in certain price increments, similar to the size increments. Likewise, the symbology encoding 104 may be configured to define a price threshold beyond with a “+” symbology may be used.

For example, Table 1C shows an example of the same actual data values shown in Table 1A but showing prices obfuscated in increments of 0.02.

| Type | Price | Actual Size |
|---|---|---|
| Ask | ≤1.05 | 18 Mio |
| Ask | ≤1.03 | 2 Mio |
| Bid | ≥1.01 | 11 Mio |
| Bid | ≥0.99 | 17 Mio |

It should be noted that two or more input value may each be obfuscated separately or together. For example, the symbology encoding 104 may be configured to obfuscate both price and size together. In this example, the symbology-based aggregator 140 may be perform price obfuscation first to aggregate multiple prices to a single observable price level, then to perform size obfuscation second to aggregate all of the quantities at that observable price-level to the corresponding range.

For example, Table 1D shows an example of the same actual data values in Table 1A with obfuscated prices (in 0.02 equal increments) and sizes (in 5 million equal increments), although other price and/or size increments may be used.

| Type | Price | Actual Size |
|---|---|---|
| Ask | ≤1.05 | ≤20 Mio |
| Ask | ≤1.03 | ≤5 Mio |
| Bid | ≥1.01 | ≤15 Mio |
| Bid | ≥0.99 | ≤20 Mio |

It should be noted that other examples in which actual values are first obfuscated by size, followed by price obfuscation. It should be further noted that symbologies may be used other than “≤” and “+” as illustrated in various examples herein, so long as they define a way to consistently obfuscate actual (or canonical) values into obfuscated (or observable) data values.

In the context of the ETV 510, one issue with trading on well-lit markets like is what is known as ‘signaling risk’. This risk is when submitting a bid or offer causes other market participants 501 to act in ways that are detrimental toward the getting the submitter's bid or offer filled. It often manifests as the submitter's bid or offer causing the market to move away from the submitter's order, or another participant bidding/offering ahead of the submitter. Signaling risk is a major disincentive to providing bids/offers into a lit market, yet lit markets require these bids and offers to serve their major function of price discovery.

Because lit venues are where price discovery occurs, and dark(er) venues depend on the lit venues for price discovery it is in the interests of the entire trading ecosystem to encourage participation on lit venues. In addition to the previously noted improvements, by partially obscuring the specific price levels at which maker orders exist and/or by partially obscuring the size at each price level participants can enter bids and offers without incurring signaling risk.

FIG. 6 illustrates an example of a computer system 600 illustrated in FIGS. 1 and 5. The computer system 600 may include, among other things, an interconnect 610, a processor 612, a multimedia adapter 614, a network interface 616, a system memory 618, and a storage adapter 620.

The interconnect 610 may interconnect various subsystems, elements, and/or components of the computer system 600. As shown, the interconnect 610 may be an abstraction that may represent any one or more separate physical buses, point-to-point connections, or both, connected by appropriate bridges, adapters, or controllers. In some examples, the interconnect 610 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1364 bus, or “firewire,” or other similar interconnection element.

In some examples, the interconnect 610 may allow data communication between the processor 612 and system memory 618, which may include read-only memory (ROM) or flash memory (neither shown), random-access memory (RAM), and/or other non-transitory computer readable media (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 612 may control operations of the computer system 600. In some examples, the processor 612 may do so by executing instructions such as software or firmware stored in system memory 618 or other data via the storage adapter 620. In some examples, the processor 612 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 614 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 616 may provide the computer system 600 with an ability to communicate with a variety of remote devices over a network. The network interface 616 may include, for example, an Ethernet adapter, a Fibre Channel adapter, and/or other wired- or wireless-enabled adapter. The network interface 616 may provide a direct or indirect connection from one network element to another, and facilitate communication and between various network elements.

The storage adapter 620 may connect to a standard computer readable medium for storage and/or retrieval of information, such as a fixed disk drive (internal or external).

Other devices, components, elements, or subsystems (not illustrated) may be connected in a similar manner to the interconnect 610 or via a network. The network may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network.

The devices and subsystems can be interconnected in different ways from that shown in FIG. 6. Instructions to implement various examples and implementations described herein may be stored in computer-readable storage media such as one or more of system memory 618 or other storage. Instructions to implement the present disclosure may also be received via one or more interfaces and stored in memory. The operating system provided on computer system 600 may be MS-DOS®, MS-WINDOWS®, OS/2®, OS X®, IOS®, ANDROID®, UNIX®, Linux®, or another operating system.

In the drawing Figures, different numbers of entities than those depicted may be used. Furthermore, according to various implementations, the components described herein may be implemented in hardware and/or software that configure hardware.

For simplicity and illustrative purposes, the disclosure included descriptions that may refer to examples. In the description, numerous specific details have been set forth in object to provide a thorough understanding of the present disclosure. It will be readily apparent however, that the disclosure may be practiced without limitation to these specific details. In other instances, some methods and structures have not been described in detail so as not to unnecessarily obscure the present disclosure. In some instances, various method operations may be omitted and the various method operations are not necessarily performed in the object in which they are presented.

Throughout the disclosure, the term “a” and “an” may be intended to denote at least one of a particular element. As used herein, the term “includes” means includes but not limited to, the term “including” means including but not limited to. The term “based on” means based at least in part on.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure. What has been described and illustrated herein is an example of the disclosure along with some of its variations. The terms, descriptions and figures used herein are set forth by way of illustration only and are not meant as limitations. As such, the disclosure is intended to be defined by the following claims—and their equivalents—in which all terms are meant in their broadest reasonable sense unless otherwise indicated.

What is claimed is:

1. A system comprising:
a processor programmed to:
access an input data value obtained from an input data message, the input data value to be obfuscated;
obtain a symbology encoding based on the input data message, the symbology encoding obfuscating the input data value based on a precision parameter of the symbology encoding for the input data message;
generate an output data value based on the input data value and the symbology encoding, the output data value obfuscating the input data value based on the precision parameter defined in the symbology encoding;
prepare an output data message based on the output data value that obfuscates the input data value; and
transmit the output data value obfuscating the input data value to one or more recipients to obfuscate the input data value while providing an indication of the input data value within the precision parameter.

2. The system of claim 1, wherein the input data value comprises a quantity value that is obfuscated based on the symbology encoding.

3. The system of claim 1, wherein the input data value comprises a price value that is obfuscated based on the symbology encoding.

4. The system of claim 1, wherein the symbology encoding comprises a precision parameter that specifies an increment, and wherein the processor is further programmed to:
generate the output data value based on a single increment applied for a plurality of intervals of ranges and the input data value is placed in one of the plurality of intervals of ranges to obfuscate the input data value.

5. The system of claim 1, wherein the symbology encoding comprises a precision parameter that specifies a plurality of increments, and wherein the processor is further programmed to:
generate the output data value based on a plurality of increments comprising a first increment that is different than a second increment, and wherein the input data value is placed in one of a plurality of intervals ranges to obfuscate the input data value.

6. The system of claim 1, wherein the symbology encoding comprises a precision parameter that specifies a terminal increment, and wherein the processor is further programmed to:
generate the output data value based on the terminal increment, and wherein the input data value is placed in one of a plurality of intervals corresponding to the terminal increment to obfuscate the input data value.

7. The system of claim 1, wherein the processor is further programmed to:
validate a data value based on the symbology encoding.

8. The system of claim 1, wherein the processor is further programmed to:
aggregate the input data value with other input data values prior to the obfuscation.

9. A method, comprising:
accessing, by a processor, an input data value obtained from an input data message, the input data value to be obfuscated;
obtaining, by the processor, a symbology encoding based on the input data message, the symbology encoding obfuscating the input data value based on a precision parameter of the symbology encoding for the input data message;
generating, by the processor, an output data value based on the input data value and the symbology encoding, the output data value obfuscating the input data value based on the precision parameter defined in the symbology encoding;
preparing, by the processor, an output data message based on the output data value that obfuscates the input data value; and
transmitting, by the processor, the output data value obfuscating the input data value to one or more recipients to obfuscate the input data value while providing an indication of the input data value within the precision parameter.

10. The method of claim 9, wherein the input data value comprises a quantity value that is obfuscated based on the symbology encoding.

11. The method of claim 9, wherein the input data value comprises a price value that is obfuscated based on the symbology encoding.

12. The method of claim 9, wherein the symbology encoding comprises a precision parameter that specifies an increment, and wherein the method further comprising:
generating the output data value based on a single increment applied for a plurality of intervals of ranges and the input data value is placed in one of a plurality of intervals of ranges to obfuscate the input data value.

13. The method of claim 9, wherein the symbology encoding comprises a precision parameter that specifies a plurality of increments, and wherein the method further comprising:
generating the output data value based on the plurality of increments comprising a first increment that is different than a second increment, and wherein the input data value is placed in one of a plurality of intervals ranges to obfuscate the input data value.

14. The method of claim 9, wherein the symbology encoding comprises a precision parameter that specifies a terminal increment, and wherein the method further comprising:
generating the output data value based on the terminal increment, and wherein the input data value is placed in one of a plurality of intervals corresponding to the terminal increment to obfuscate the input data value.

15. The method of claim 9, further comprising:
validating a data value based on the symbology encoding.

16. The method of claim 9, further comprising:
aggregating the input data value with other input data values prior to the obfuscation.

17. A non-transitory computer-readable medium that stores instructions that when executed by a processor, causes the processor to:
access an input data value obtained from an input data message, the input data value to be obfuscated;
obtain a symbology encoding based on the input data message, the symbology encoding obfuscating the input data value based on a precision parameter of the symbology encoding for the input data message;
generate an output data value based on the input data value and the symbology encoding, the output data value obfuscating the input data value based on the precision parameter defined in the symbology encoding;
prepare an output data message based on the output data value that obfuscates the input data value; and
transmit the output data value obfuscating the input data value to one or more recipients to obfuscate the input data value while providing an indication of the input data value within the precision parameter.

18. The non-transitory computer-readable medium of claim 17, wherein the input data value comprises a quantity value that is obfuscated based on the symbology encoding.

19. The non-transitory computer-readable medium of claim 17, wherein the input data value comprises a price value that is obfuscated based on the symbology encoding.

20. The non-transitory computer-readable medium of claim 19, wherein the symbology encoding comprises a precision parameter that specifies an increment, and wherein the instructions, when executed, further programs the processor to:
generate the output data value based on a single increment applied for a plurality of intervals of ranges and the input data value is placed in one of a plurality of intervals of ranges to obfuscate the input data value.
